(19) United States
(12) Patent Application Publication
(10) Pub. No.: US 2022/0067586 A1
(43) Pub. Date: Mar. 3, 2022

(54) IMAGING SYSTEMS WITH HYBRID LEARNING

(71) Applicant: Yudong Zhu, Scarsdale, NY (US)

(72) Inventor: Yudong Zhu, Scarsdale, NY (US)

(21) Appl. No.: 17/472,635

(22) Filed: Sep. 11, 2021

Related U.S. Application Data
(63) Continuation of application No. 16/203,610, filed on Nov. 29, 2018, now abandoned.

(51) Int. Cl. G06N 20/00; G06N 5/04

(52) U.S. Cl. CPC G06N 20/00; G06N 5/04

(57) ABSTRACT

Techniques are presented that exploit human learning and machine learning in the acquiring of and reasoning with sensor data. To reveal quantities of interest of the physical world, instrument-based sensing or probing can particularly use, in a hybrid fashion, elements such as scientific models and problem solving experiences originated from human learning of the operation principles of the physical world, together with elements such as adaptive compute units or neural networks constructed for machine learning of patterns in high-dimensional space and in massive data. Integration and autonomous improvement are through numerical computations and schemed updates, which can benefit development or deployment of algorithms, procedures and sensors, as well as interpretation of results.

This is a continuation of application Application Number 16203610, filed 2018 Nov. 29. This application claims the benefit of PPA Application Number 62591253 filed 28 Nov. 2017 by the present inventor, which are incorporated by reference.

### BRIEF DESCRIPTION OF THE DRAWINGS

FIG. 1 illustrates utilization, in accordance with aspects of the present invention, of both human learning and machine learning on an imaging system with hybrid learning.

FIG. 2A-2B illustrate utilization, in accordance with aspects of the present invention, of both human learning and machine learning on an imaging system with hybrid learning.

FIG. 3A-3D illustrate variants of practicing hybrid learning.

FIG. 4A-4C illustrate various techniques for defining and quantifying loss or cost.

FIG. 5A-5B illustrate an example of integrating physics-based modeling, as applicable to parallel receive MRI, into machine learning.

FIG. 6A-6C illustrate an example of integrating physics-based modeling, as applicable to MRI, with a structure model obtained from machine learning.

FIG. 7 illustrates an example of practicing hybrid learning in a multi-parameter and multi-configuration MR imaging setting.

FIG. 8 is a schematic block diagram of a magnetic resonance imaging system for use with the present invention.

### DETAILED DESCRIPTION

Numerous instruments function by essentially carrying out experiments, collecting signals with sensors, and fitting sensor data to scientific models. Developers of such instruments typically task themselves to deploy sensors for signal detection, to design procedures for systematic collection of signals, to devise operations for inference or reconstruction of unknown quantities of interest based on the collected signal data and applicable scientific models, and to present the inference or reconstruction results in easy-to-interpret formats.

Medical imaging equipment is a good example. A CT or MRI scanner for instance, uses sensors carefully configured near a scanned target to detect signals containing diagnostic information, uses developer-crafted measurement procedures or sequences to collect signal data, and uses developer-crafted operations to reconstruct quantities of diagnostic value (often in the form of images) based on the collected data and established models (e.g., attenuation model in CT, and Bloch equation in MRI), and finally presents results for radiologists to read.

New instruments with hybrid learning, including improved medical imaging systems, are hereby described. Each of these instruments has human learning elements making one part of its core, but has machine learning elements replacing many of the other human design/devise elements (which include, for example, development or deployment of sensors, procedures and operations, as well as interpretation of results) making the other part. The human learning elements include scientific models and problem solving experiences. Further, the machine learning part is optionally set to evolve or optimize continuously, leveraging features continuously learned from data throughout the use cycle of the instruments.

The new instruments are hybrid learning machines—they function by utilizing both human learning and machine learning elements. While the former often excels in representing or modeling with elegance and depth the operation principles of the physical world (e.g., in the form of equations expressing laws of the physical world, high quality computer simulations, or designed quantitative experiments) thereby linking sensor data to underlying unknown quantities of interest or in effect defining an inverse problem, the latter is becoming increasingly powerful spotting patterns in massive data and in high-dimensional space, and responding autonomously with solution strategies for inferring or reconstructing the unknown quantities. On the new instruments the two learning paradigms work together in deducing the unknown quantities given sensor data—they accomplish this by changing conventional instruments with improved sensor configurations, measurement procedures and inference operations.

In an exemplary instrument with hybrid learning, adaptive instrument control variables are established, including a set of parameters that reside in an adaptive compute unit (ACU) that is part, a set of parameters that specify experimental configurations (e.g., sensor configuration parameters and measurement procedure parameters), or both. The human established models and experiences are employed to guide both the set-up of the ACU for carrying out machine learning, and the set-up of measurement procedures and sensor configurations. Data samples are employed to guide the adaptation of the instrument control variables, effecting optimization of the ACU, the experimental configurations, or both. The ACU may be a neural network of a properly set structure, in which case aforementioned ACU parameters are neural network weights. In a training the instrument control variables are optimized in accordance with data samples and properly defined loss or cost metrics. The training may additionally source data samples used in training from human learning elements, including equations expressing laws of the physical world, high quality computer simulations, and designed quantitative experiments. The optimization of the set of ACU parameters, the set of experimental configuration parameters, or both, uses gradient descent and gradient back propagation techniques of machine learning, and optimization techniques, and can take advantage of the often differentiable scientific models. In an execution, the instrument applies the parameter-optimized experimental configurations when available, performs measurement procedures and collects signal data with sensors, and conducts inference based on the sensor data, the parameter-optimized ACU, and applicable scientific models. In this fashion, the elements adapt or change the instrument and its operation, effecting higher quality inference results, lower measurement requirements (e.g., requirements on the duration, sensitivity and data amount), or both.

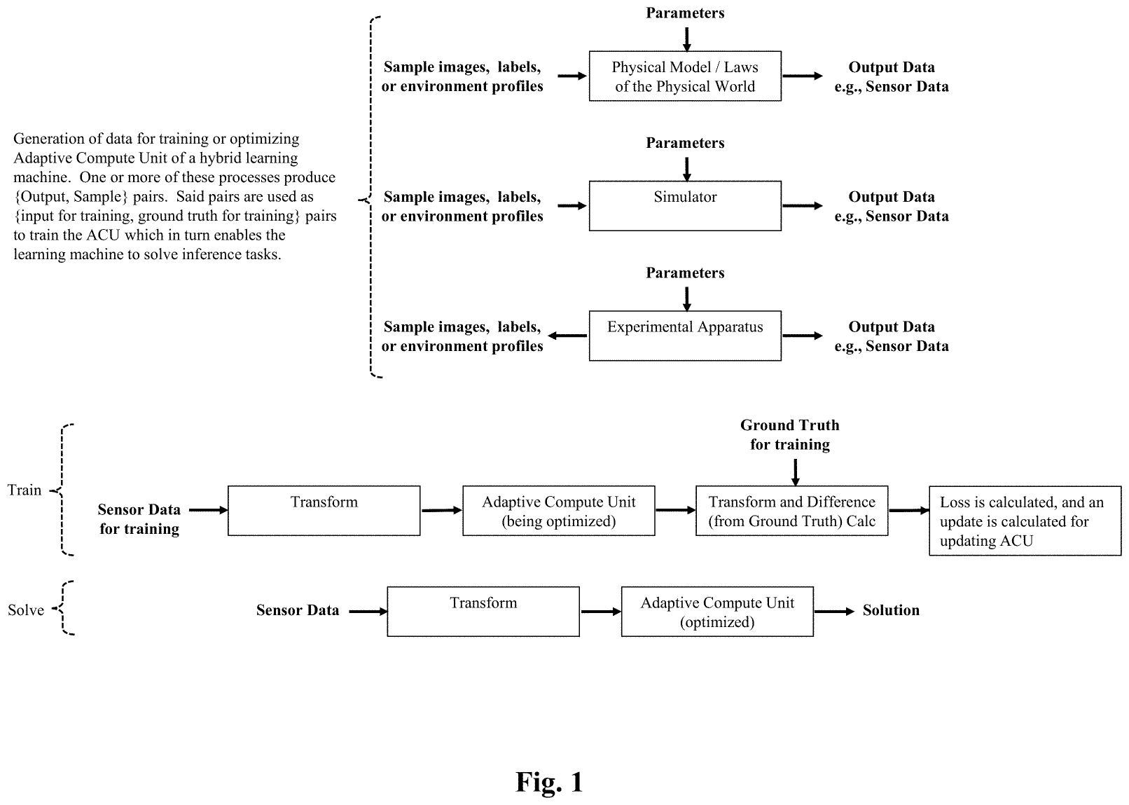

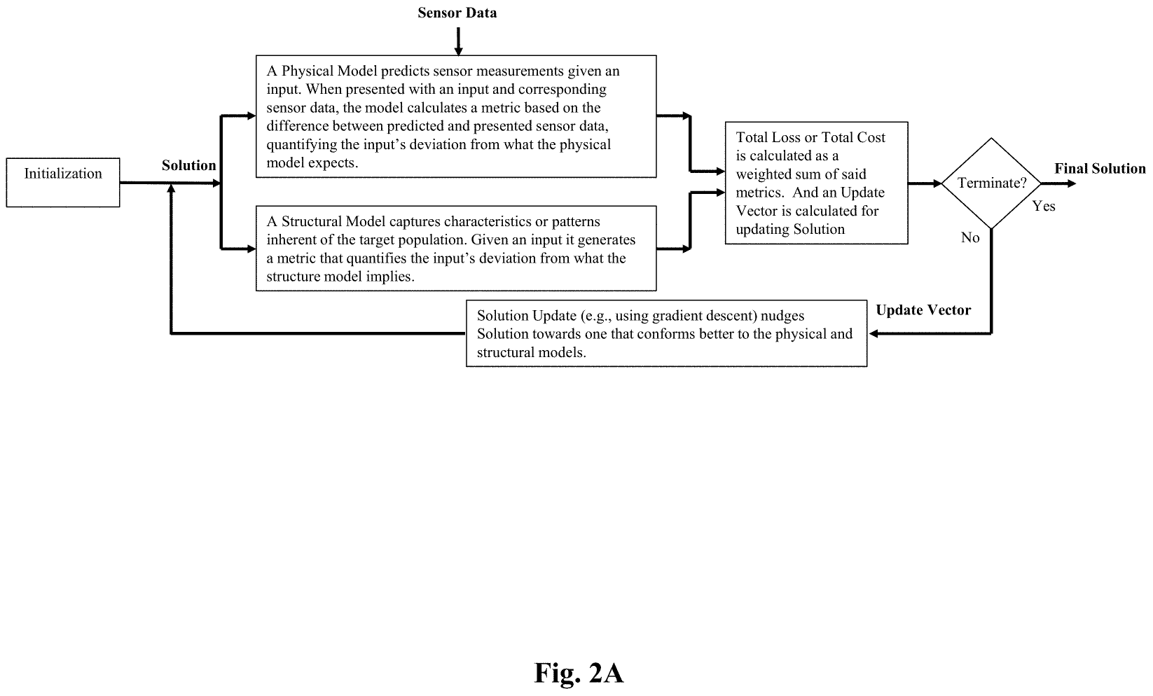

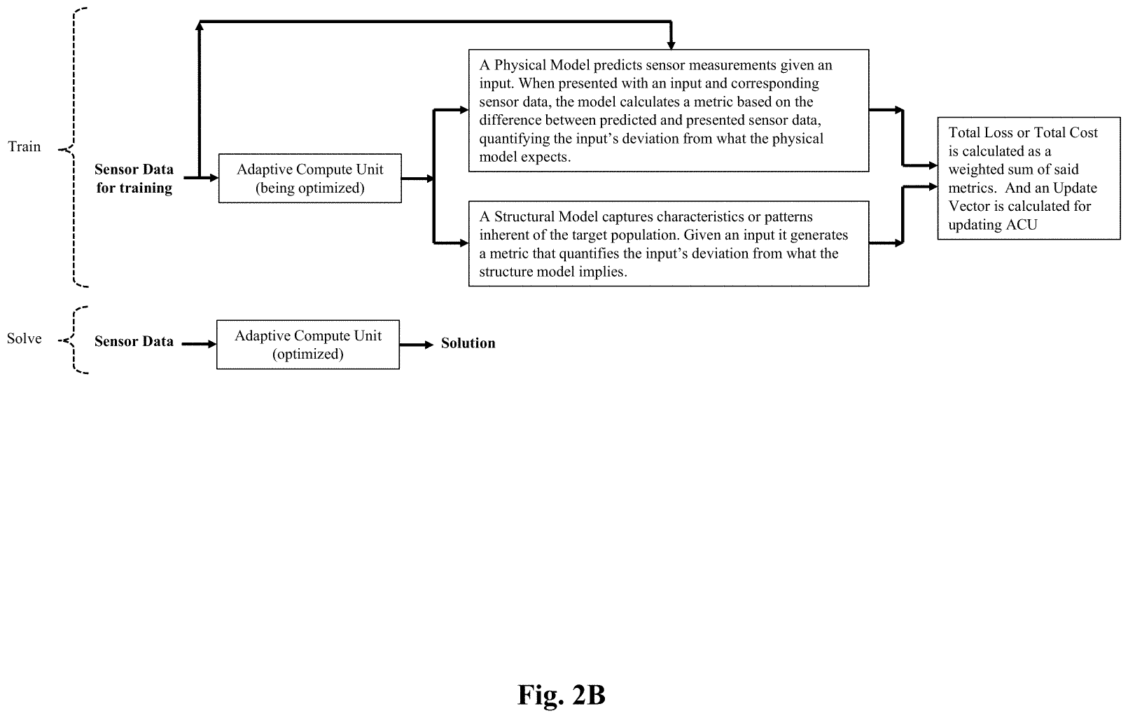

Two further embodiments are illustrated in FIGS. 1 and 2.

An instrument with hybrid learning solves inference problems by applying both human learning and machine learning. This may be embodied in the establishment and use of ACU as an integral part of the instrument. As a result of human learning, laws of the physical world, high quality simulations and designed experiments, for example, are often good at quantifying or summarizing behaviors of interest. One can instill or integrate them into a machine learning paradigm to enhance the quality and speed of training/optimizing an ACU, and to facilitate the creation of an autonomous problem solving machine. FIG. 1 illustration exemplifies, for example, a medical imaging equipment, whose task is to acquire sensor data and infer an image or a series of images based on the sensor data. There are two phases involved—the train phase that sets up the inference pipeline and the solve phase that performs the inference in an actual imaging instance. TOP: In generating data required by the training phase, one may use one or more of several processes. The processes generate data for training by leveraging human learning results. Sample images or labels in this case can be extracted from existing images or studies of actual objects. For example, the sample images or labels are derived from available image collections or PACS systems, synthesized by computation means, or produced through designed experiments. Applying laws of the physical world, high quality simulations or designed experiments, with certain parameters and environment configurations, quantifies/produces sensor responses. The resulting training data reflect both the human learning results and the statistical pattern or distribution of the target population (e.g. a manifold). Data for training are optionally generated by a more conventional means, which, in comparison, could be burdensome and less effective. Middle and Bottom: The generated training data are, for example, used as {Sensor Data, Ground Truth} pairs to train the ACU, effecting exploitation of human learning results. Upon completion the trained ACU is deployed for use, where it solves an inference task by producing image(s)/label(s) in one pass using sensor data that are acquired by the equipment in an actual instance.

An instrument with hybrid learning solves inference problems by applying both human learning and machine learning. This may be embodied in an iterative process on the instrument as well as in an ACU of the instrument. FIG. 2 illustration exemplifies, for example, a medical imaging equipment, whose task is to acquire sensor data and infer an image or a series of images based on the sensor data. This illustration exemplifies an approach of finding a solution by balancing outcome's conformation to both human learning results (e.g., laws of the physical world or high quality simulations) and separate machine learning results (e.g., an auto-encoder or discriminator that judges conformity with established statistical patterns or distributions). The usual requirement of having access to quality ground truth data is removed. The structural model, implemented for example with a dedicated ACU (e.g., a neural network), is established/trained in a separate process that have access to samples from a population of a same statistical pattern or distribution, but not necessarily involved in the present development. Sub-figures illustrate function modules and data flows in examples where an iterative technique (A) or a train-and-solve technique (B) is used. In this embodiment, with access to an ever increasing amount of samples locally or from an independent source as time goes by, the instrument can periodically update/retrain the structural model itself to improve its effectiveness, effecting an autonomous self-improving mechanism.

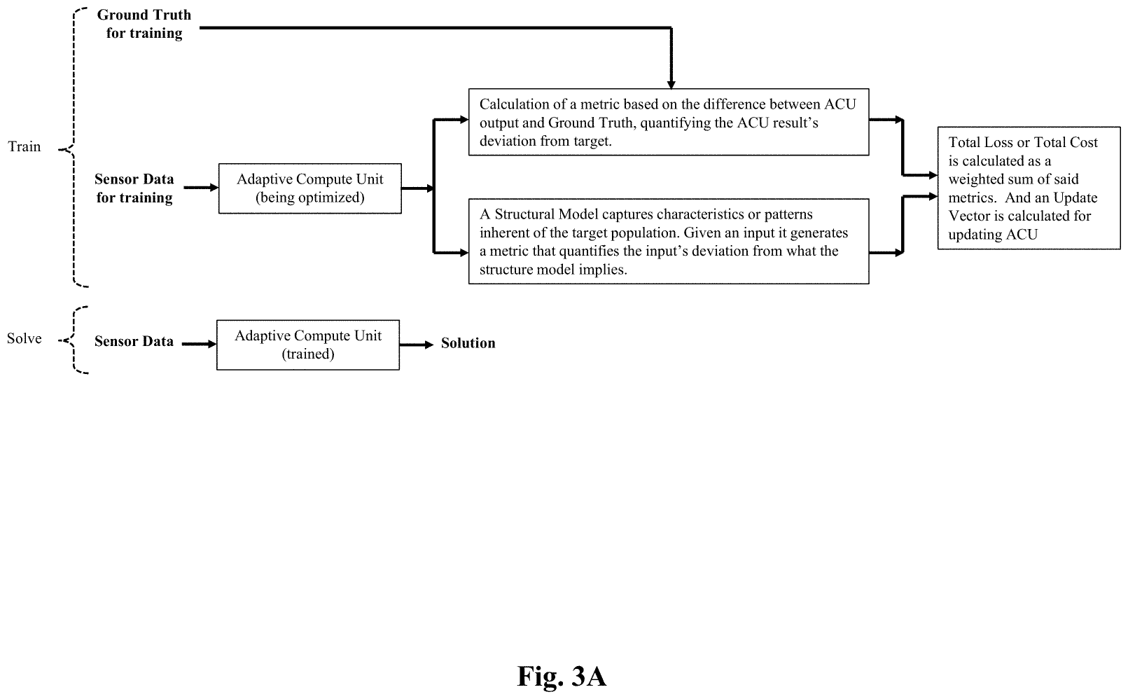

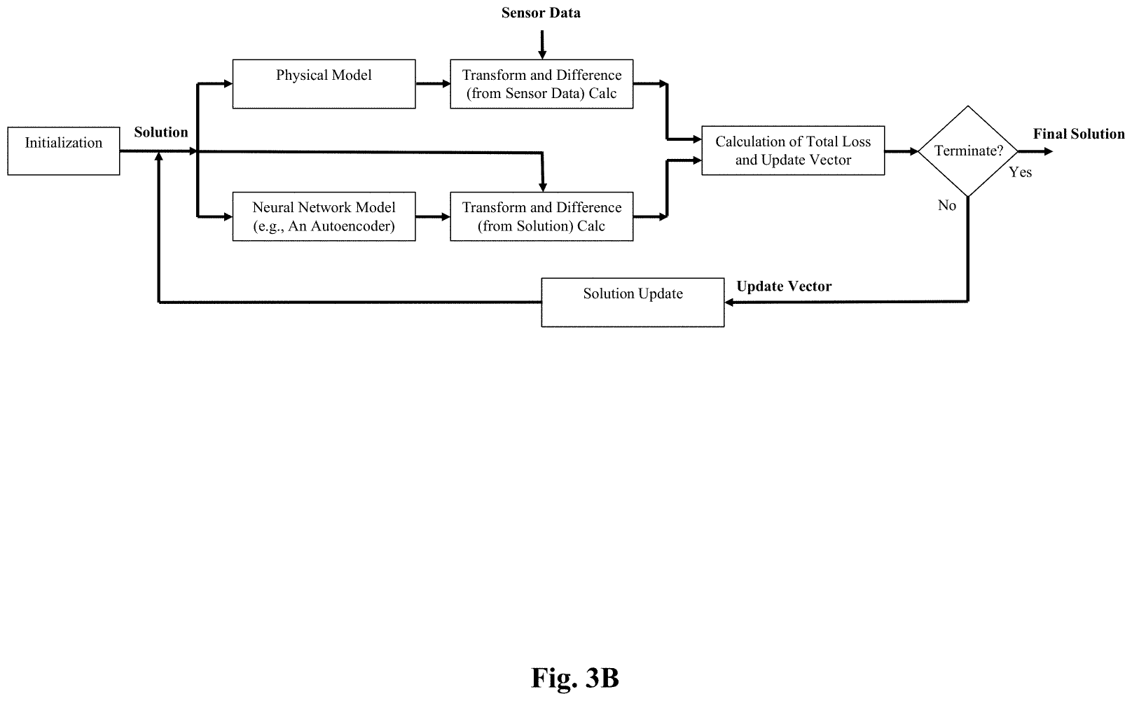

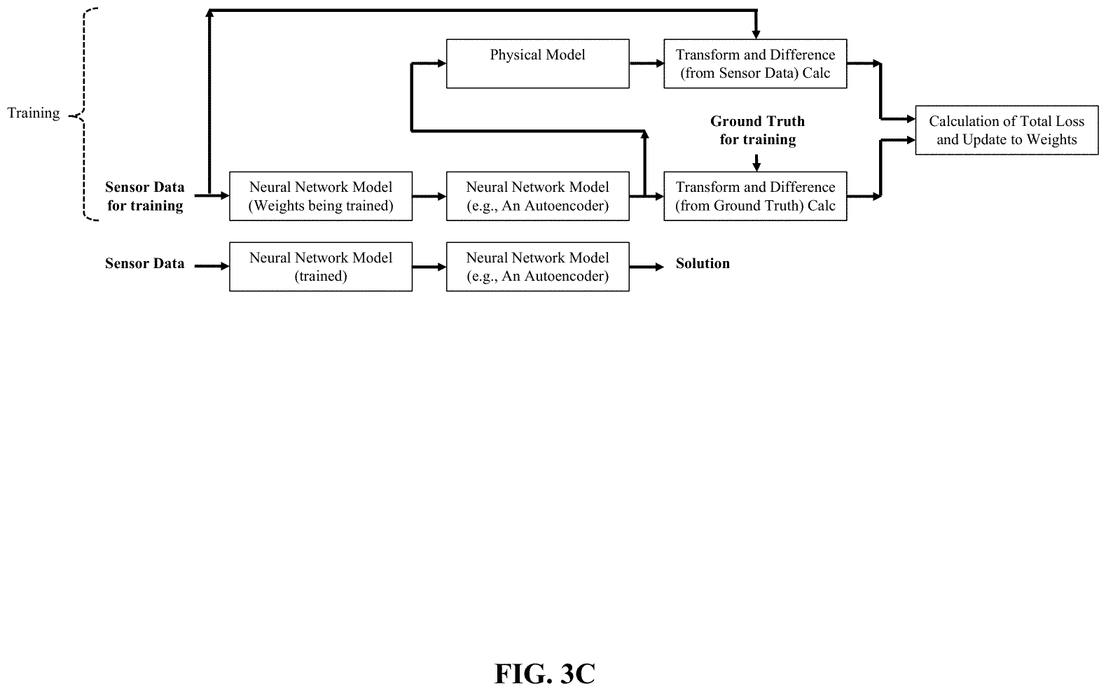

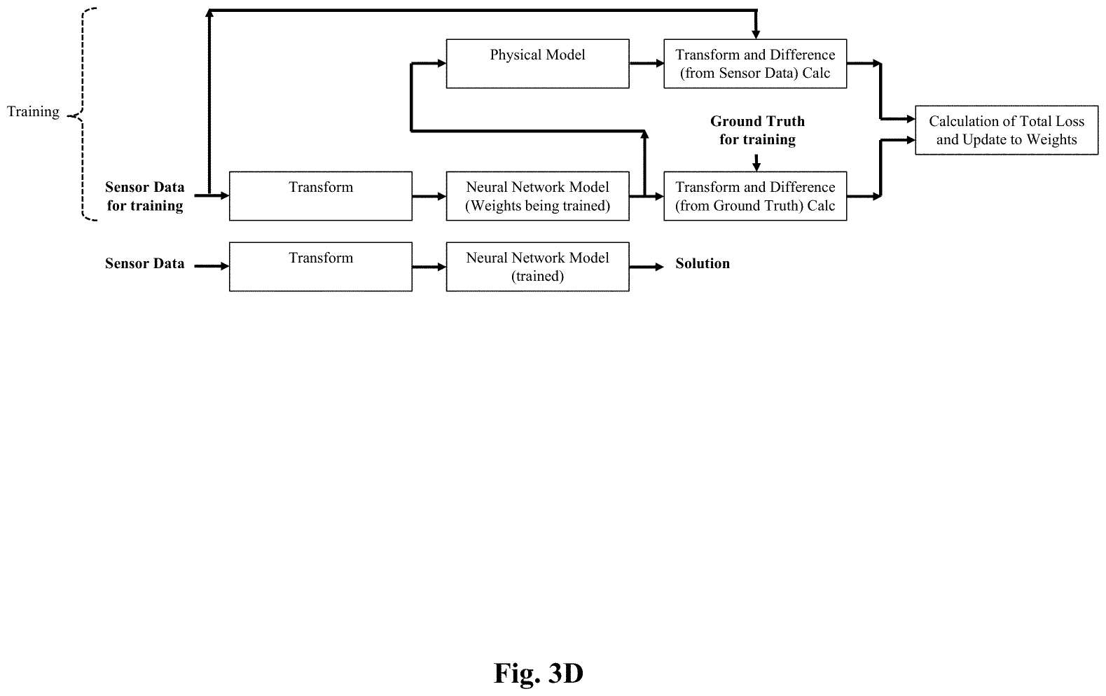

Variants or more specialized versions of the above embodiments are illustrated in FIGS. 3A-3D. FIG. 3A Train-and-solve: an ACU is built based on end-to-end training, and then deployed to generate solution in one pass. FIG. 3B Iteratively solve: starting with an initial guess, a solution is iteratively refined until a termination criteria is met. Also note the option of building and perfecting the Neural Network Model using only modality-specific quality images, independent of other models and considerations. FIG. 3C Train-and-solve: a neural network model is built based on end-to-end training, and then deployed to generate solution in one pass. FIG. 3D Train-and-solve: a neural network model is built based on end-to-end training, and then deployed to generate solution in one pass.

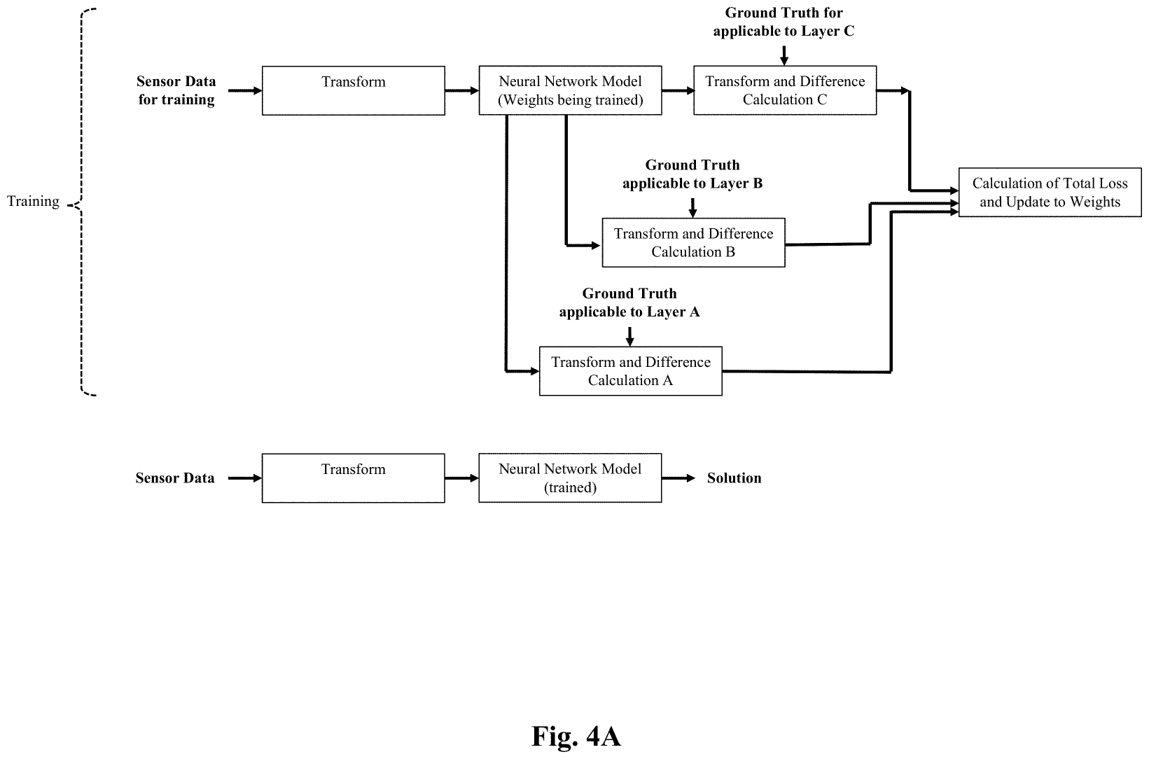

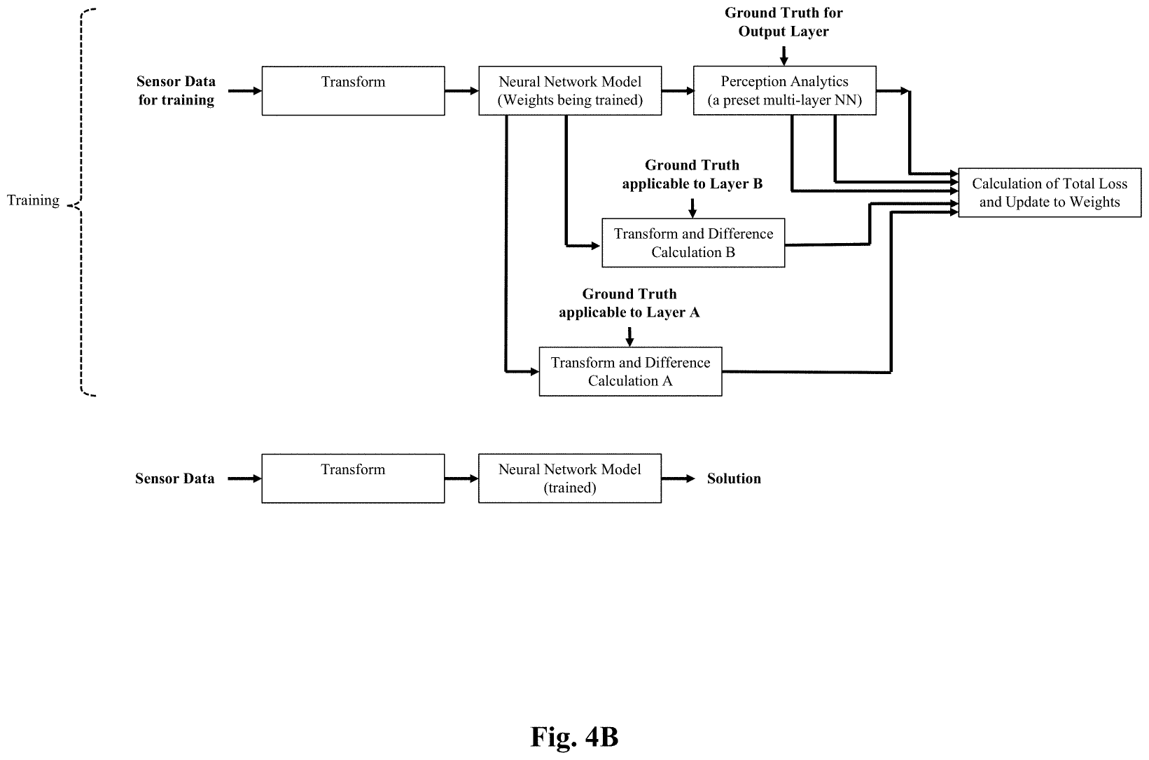

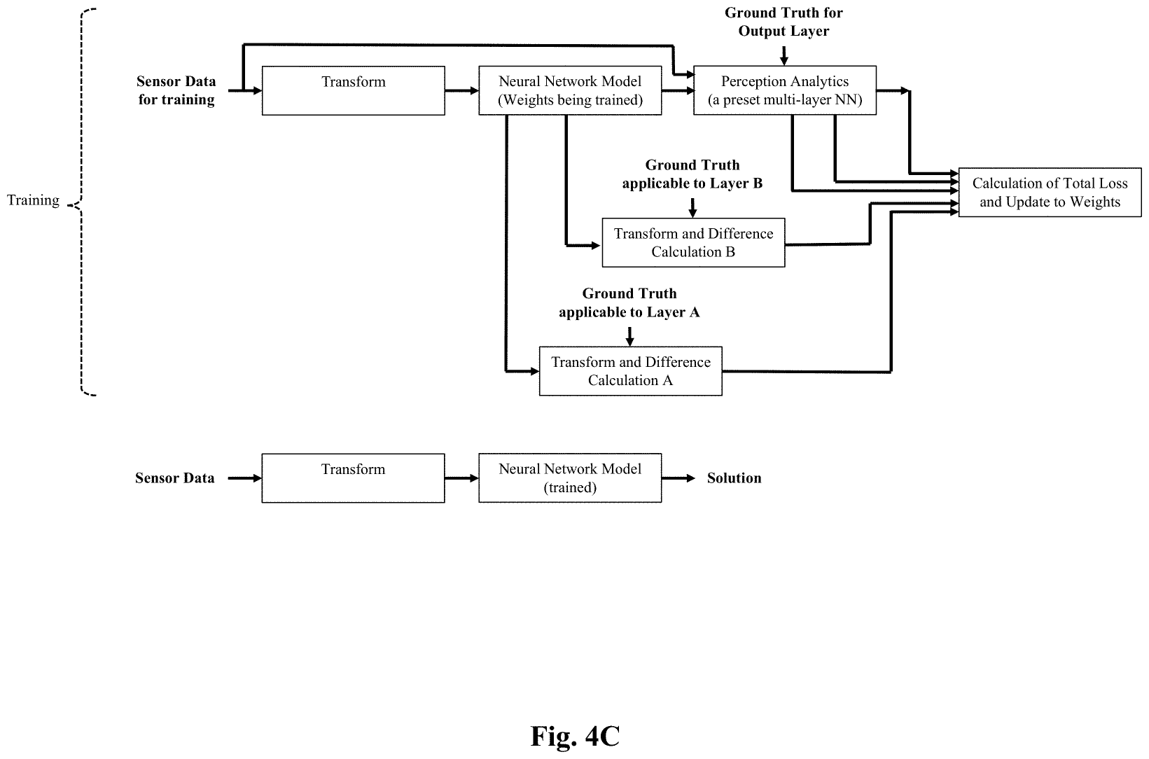

Note that descriptions of the present invention use terms cost and loss interchangeably. Either one is a commonly used term in optimization and machine learning, representing an objective function (e.g., a mean squared error, a weighted sum of lₚ norms of deviations or differences) that is to be minimized. Cost or loss quantification provides the driving force for the adaptation or optimization of the ACU, and its specific definition directly influences the outcomes' quality as well as the optimization landscape. FIGS. 4A-4C illustrate various techniques for defining and quantifying (total) loss, including (A) checking intermediate-layer outcomes in addition to the last-layer outcome of the neural network being trained, (B) using a dedicated discerning neural network to strengthen visual quality assessment and improvement, and (C) incorporating an element that expands discerning power with a direct, physics-based modeling of the sensor data (e.g., inter-channel signal correlation in parallel receive MRI).

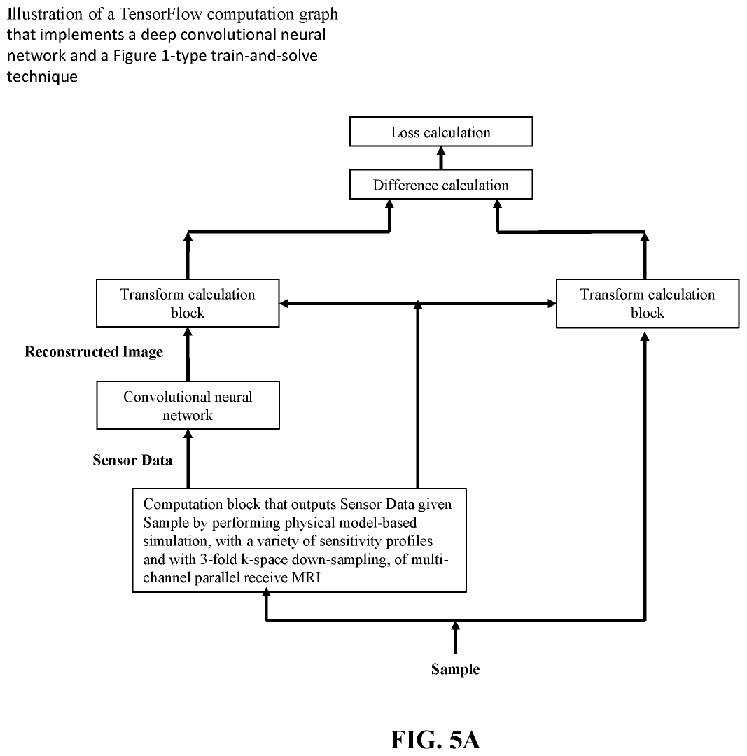

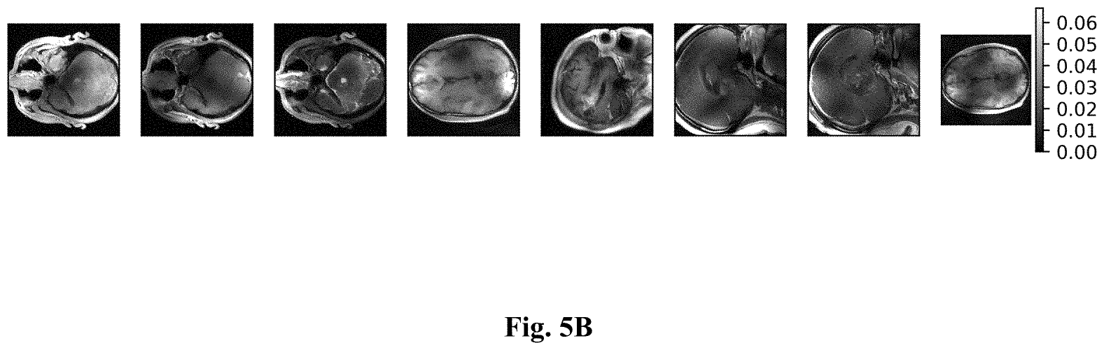

One embodiment furthering that illustrated in FIG. 1 is illustrated in FIG. 5. It includes integration into machine learning physics based modeling applicable to parallel receive MRI (which are mathematical expressions derived from Bloch equation that governs spin dynamics and Maxwell's equations that govern electromagnetic field variation) . It uses TensorFlow (a computation graph) for implementing a deep convolutional neural network and a FIG. 1-type train-and-solve technique. In the solve phase of 8 example cases, when presented with parallel receive signal data corresponding to various random or even 3-fold down-sampling of k-space and various multi-channel receive sensitivity profiles, the trained network reconstructed images (FIG. 5B) that are in good agreement with results from full Nyquist-rate k-space sampling and standard root sum-of-squares reconstruction.

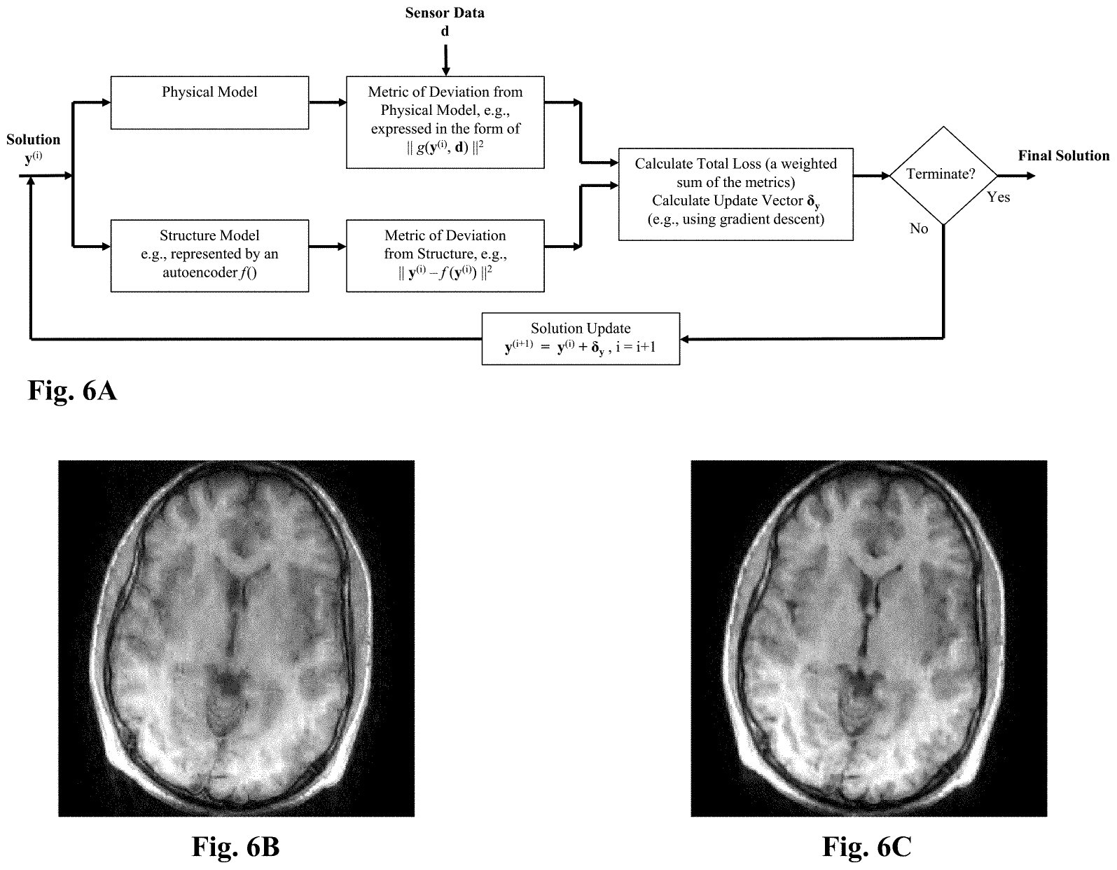

One embodiment furthering that illustrated in FIG. 2A is illustrated in FIG. 6. It includes integration with machine learning, physics-based modeling applicable to MRI. It employs an iterative scheme and finds a solution by balancing outcome's conformation to both laws of the physical world (Bloch equation and Maxwell's equations) and a structure model that identifies outcome's statistical patterns or distributions. The structure model is an auto-encoder in one implementation, and the auto-encoder, based on a GAN-type neural network, is independently trained with MR images collected from a variety of sources. FIG. 6C shows an example outcome of applying the present scheme in an MR scan, where neither the human subject nor the MR scanner was involved in the establishment of the structure model. At a relatively high scan acceleration in this case—6-fold acceleration in 8-channel parallel receive MRI—the present scheme significantly outperformed a compressed sensing-based scheme (result shown in FIG. 6B), demonstrating a potential for driving MRI performance beyond the state-of-the-art.

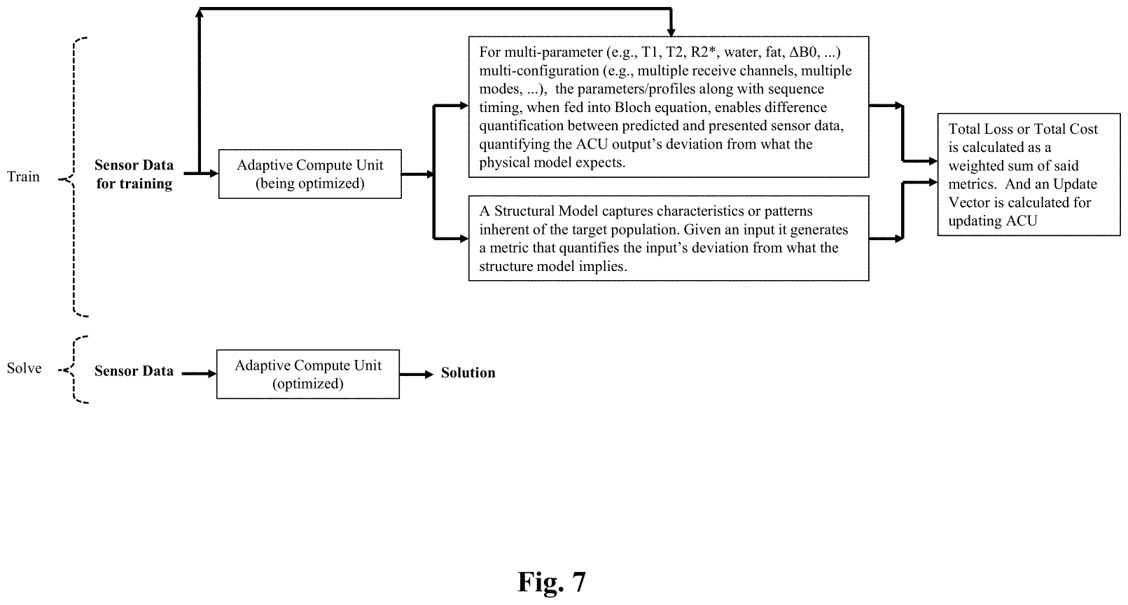

FIG. 7 illustrates an embodiment furthering FIG. 2B-type embodiment in a multi-parameter and multi-configuration MR imaging setting. Notice that FIG. 1-type embodiment can be tailored to handle multi-parameter multi-configuration MRI too, where the model- or simulator-based processes can be very effective, with sample images including T1, T2, proton density and off-resonance maps, and with environmental profiles including RF and static field profiles. An example multi-parameter multi-configuration MRI scenario is water-fat separation in MRI. Dixon's model, derived from Bloch equation model, relates sensed multi-echo signals (s) to water and fat images (ρ_{w} and ρ_{F}) as follows:

s(r,tₙ)=(ρ_{W}(r)+ρ_{F}(r)e^{j2πf}^{_{F}}^{t}^{ₙ})e^{-R}^{₂}^{*(r)t}^{ₙ}^{+j2πΔB}^{₀}^{(r)t}^{ₙ}

where tₙ, n=1, 2, 3, . . . denotes a string of echo time (TE) shifts, r denotes voxel location, f_{F} denotes frequency shift (in Hz) of fat relative to water, ΔB₀ is local frequency shift (in Hz) due to static field inhomogeneity, and R₂* represents T₂* effect.

There are explicitly controllable parameters in experiments, including, in MRI for example, sequence timing, RF excitation strength, gradient trajectories, receive coil configuration and etc. By adding to the total cost optimization an additional target such as SNR and imaging speed, the imaging system with hybrid learning can use techniques including gradient descent and gradient back propagation to further optimize these controllable parameters and to achieve performance gains, leveraging, in a unique way, both models established for the physical world and patterns identified in high-dimensional space and in massive data.

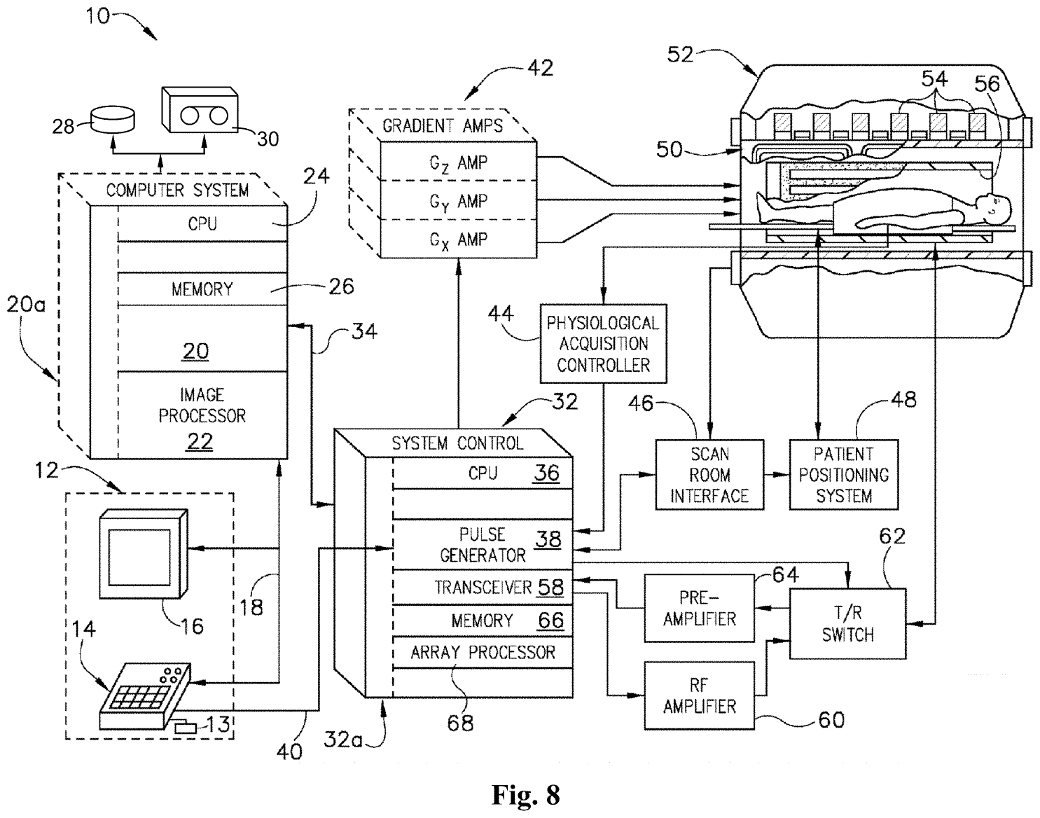

Referring to FIG. 8, the major components of an example magnetic resonance imaging (MRI) system 10 incorporating the present invention are shown. The operation of the system is controlled from an operator console 12 which includes a keyboard or other input device 13, a control panel 14, and a display screen 16. The console 12 communicates through a link 18 with a separate computer system 20 that enables an operator to control the production and display of images on the display screen 16. The computer system 20 includes a number of modules which communicate with each other through a backplane 20a. These include an image processor module 22, a CPU module 24 and a memory module 26, known in the art as a frame buffer for storing image data arrays. The computer system 20 is linked to disk storage 28 and tape drive 30 for storage of image data and programs, and communicates with a separate system control 32 through a high speed serial link 34.

The system control 32 includes a set of modules connected together by a backplane 32a. These include a CPU module 36 and a pulse generator module 38 which connects to the operator console 12 through a serial link 40. It is through link 40 that the system control 32 receives commands from the operator to indicate the scan sequence that is to be performed. The pulse generator module 38 operates the system components to carry out the desired scan sequence and produces data which indicates, for RF transmit, the timing, strength and shape of the RF pulses produced, and, for RF receive, the timing and length of the data acquisition window. The pulse generator module 38 connects to a set of gradient amplifiers 42, to indicate the timing and shape of the gradient pulses that are produced during the scan. The pulse generator module 38 can also receive patient data from a physiological acquisition controller 44 that receives signals from a number of different sensors connected to the patient, such as ECG signals from electrodes attached to the patient. And finally, the pulse generator module 38 connects to a scan room interface circuit 46 which receives signals from various sensors associated with the condition of the patient and the magnet system. It is also through the scan room interface circuit 46 that a patient positioning system 48 receives commands to move the patient to the desired position for the scan.

The gradient waveforms produced by the pulse generator module 38 are applied to the gradient amplifier system 42 having Gx, Gy, and Gz amplifiers. Each gradient amplifier excites a corresponding physical gradient coil in a gradient coil assembly generally designated 50 to produce the magnetic field gradients used for spatially encoding acquired signals. The gradient coil assembly 50 and a polarizing magnet 54 form a magnet assembly 52. An RF coil assembly 56 is placed between the gradient coil assembly 50 and the imaged patient. A transceiver module 58 in the system control 32 produces pulses which are amplified by an RF amplifier 60 and coupled to the RF coil assembly 56 by a transmit/receive switch 62. The resulting signals emitted by the excited nuclei in the patient may be sensed by the same RF coil assembly 56 and coupled through the transmit/receive switch 62 to a preamplifier module 64. The amplified MR signals are demodulated, filtered, and digitized in the receiver section of the transceiver 58. The transmit/receive switch 62 is controlled by a signal from the pulse generator module 38 to electrically connect the RF amplifier 60 to the coil assembly 56 during the transmit mode and to connect the preamplifier module 64 to the coil assembly 56 during the receive mode. The transmit/receive switch 62 can also enable a separate RF coil (for example, a surface coil) to be used in either the transmit or receive mode. The transceiver module 58, the separate RF coil and/or the coil assembly 56 are commonly configured to support parallel acquisition operation.

The MR signals picked up by the separate RF coil and/or the RF coil assembly 56 are digitized by the transceiver module 58 and transferred to a memory module 66 in the system control 32. A scan is complete when an array of raw k -space data has been acquired in the memory module 66. This raw k-space data is rearranged into separate k-space data arrays for each image to be reconstructed, and each of these is input to an array processor 68 which operates to Fourier transform the data to combine MR signal data into an array of image data. This image data is conveyed through the serial link 34 to the computer system 20 where it is stored in memory, such as disk storage 28. In response to commands received from the operator console 12, this image data may be archived in long term storage, such as on the tape drive 30, or it may be further processed by the image processor 22 and conveyed to the operator console 12 and presented on the display 16.

An ACU is suitably hosted by a hardware structure comprising GPU(s) and/or specialized integrated circuit chip(s) in parallel to or inside of COMPUTER SYSTEM 20. Adaptive instrument control variables are executed both on SYSTEM CONTROL 32 and COMPUTER SYSTEM 20 to effect improvements in operation of the MRI system, such improvements including speed-up of scans, better placement and configuration of RF Coil Assembly 56, enhanced resolution and quality of image production, and etc.

While the above descriptions of methods and systems contain many specificities, these should not be construed as limitations on the scope of any embodiment, but as exemplifications of the presently preferred embodiments thereof. Many other ramifications and variations are possible within the teachings of the various embodiments.

1. An imaging system with hybrid learning, comprising:
a. at least one sensor for acquiring signal data,
b. a machine learning element, said machine learning element comprising at least one adaptive compute unit,
c. at least one representation from human learning,
d. a cost computation element for quantifying a cost using said machine learning element and said at least one representation from human learning,
e. an integration means for updating and delivering, comprising:
an update computation element that solves optimization of said cost and generates at least one set of numerical values for updating
a delivering element that uses said at least one set of numerical values for updating to advance a task of inferring at least one image from said signal data, revising said at least one adaptive compute unit, or adjusting said imaging system's experimental configuration,
whereby integration of said machine learning and human learning elements enhances capabilities of said imaging apparatus.

2. The system of claim 1 wherein said at least one representation from human learning is a characterization of the physical world behavior, the form of said characterization being selected from the group comprising a mathematical equation, a computation graph, a plurality of quantitative data pairs, computer simulations, and quantitative experiments.

3. The system of claim 1 wherein said at least one adaptive compute unit comprises a neural network.

4. The system of claim 3 wherein said at least one representation from human learning generates guidance to the training of said neural network

5. The system of claim 1 wherein said update computation element employs gradient descent calculations.

6. The system of claim 1 wherein said integration means employs a predetermined scheme for updating and delivering.

7. The system of claim 6 wherein said predetermined scheme is a scheme of iterative-solve, train-and-solve, or periodical-retrain.

8. The system of claim 1 wherein said adjusting of experimental configuration entails adjusting parameters of said imaging system's sensor setup, data acquisition process, or data acquisition environment.

9. The system of claim 1 wherein said cost includes a component computed by a discerning element.

10. The system of claim 1 wherein said system is a magnetic resonance imaging system and said at least one representation is derived from Bloch equation or Maxwell's equations.

11. The system of claim 1 wherein said system is a magnetic resonance imaging system and said adjusting entails modifying parameters of said system's coil configuration, imaging sequences, magnetic field profiles, or radio-frequency field profiles.

12. A method for operating an imaging system using numerical integration of machine learning and human learning, comprising:
a. providing at least one sensor for acquiring signal data,
b. defining a cost,
c. providing an adaptive compute unit and incorporating machine learning in the quantification of said cost,
d. deriving at least one representation from human learning and incorporating said at least one representation in the quantification of said cost,
e. computing at least one update as guided by said cost through solving an optimization problem, said solving exploiting said adaptive compute unit with a predetermined scheme,
f. delivering a result based on said at least one update, said result being at least one image inferred from said signal data, a revision to said adaptive compute unit, or an adjustment to said imaging system's experimental configuration,
whereby said machine learning and said human learning together effect performance improvement of said imaging system.

13. The method of claim 12 wherein said at least one representation from human learning is a characterization of the physical world behavior, the form of said characterization being selected from the group comprising a mathematical equation, a computation graph, a plurality of quantitative data pairs, computer simulations, and quantitative experiments.

14. The method of claim 12 wherein said adaptive compute unit comprises a neural network.

15. The method of claim 14 wherein said at least one representation from human learning effects guidance to the training of said neural network

16. The method of claim 12 wherein said predetermined scheme is a scheme of iterative-solve, train-and-solve, or periodical-retrain.

17. The method of claim 12 wherein said solving employs gradient descent calculations.

18. The method of claim 12 wherein said adjusting of experimental configuration entails adjusting parameters of said imaging system's sensor setup, data acquisition process, or data acquisition environment.

19. The method of claim 12 wherein said cost includes a component computed by a discerning element.

20. Non-transitory computer readable media whose contents, when executed, cause improved inferences and enhanced sensing capabilities, comprising:
a. computer readable code M for training or deploying at least one adaptive compute unit,
b. computer readable code H for executing at least one representation from human learning,
c. computer readable code C for quantifying a cost metric using said code M or said code H,
d. computer readable code U that solves optimization of said cost and generates at least one set of numerical values for updating,
e. computer readable code D that further applies said at least one set of numerical values to advance a task of inferring from sensor data, revising parameters of code M, or suggesting parameter adjustments to data sensing.
